(19) United States
(12) Patent Application Publication
(10) Pub. No.: US 2010/0068932 A1
(43) Pub. Date: Mar. 18, 2010

(54) ELECTRICAL CONNECTOR WITH METAL SHEATH

(76) Inventor: Chou Hsien Tsai, SinJhuang City (TW)

Correspondence Address: Chou Hsien Tsai, 8F-3,No.26,Wu-Chun 2nd Rd.,WuKu 1nd.,, Taipei Hsien, SinJhuang City, 24892, TW

(21) Appl. No.: 12/558,933

(22) Filed: Sep. 14, 2009

(30) Foreign Application Priority Data
Sep. 15, 2008 (TW) 097135368
Jun. 17, 2009 (TW) 098120366

(51) Int. Cl. H01R 13/648

(52) U.S. Cl. 439/607.01

(57) ABSTRACT

An electrical connector includes: a plastic base formed with terminal slots; terminals disposed in the terminal slots; a metal sheath disposed at one end of the plastic base and formed with two lateral planes and a middle projection; at least one screw hole member disposed on one side of the plastic base and connected to the lateral plane, wherein the screw hole member has first and second plates, a surface of the first plate is disposed at the one end of the plastic base and is formed with a screw hole on the middle of the surface of the first plate, and the second plate is integrally connected to one end of the first plate and extends to the other end of the plastic base; and at least one connecting element having a lower section formed with a connection portion, and a top end connected to the second plate.

### BACKGROUND OF THE INVENTION

1. Field of the Invention

The invention relates to an electrical connector, and more particularly to an electrical connector with a metal sheath.

2. Related Art

Referring to FIGS. 1 and 2, an electrical connector includes a plastic base 10, terminals 14, a metal sheath 15, two connecting elements 20, two rivets 25 and two screw elements 28. The plastic base 10 is formed with terminal slots and two through holes 12 respectively formed on two sides of the terminal slots. The terminals 14 are respectively disposed in the terminal slots of the plastic base 10. A pin of the terminal 14 extends out of the plastic base 10. The metal sheath 15 is disposed on a front end of the plastic base 10, and has two lateral planes 16 and a middle projection 17. Each of the two lateral planes 16 has a through hole 18. The two connecting elements 20 are positioned on two sides of the rear side of the plastic base 10. A lower section of the connecting element has an elastic hook 21. An upper section of the connecting element has a positioning plate 22. The positioning plate 22 has a through hole 23. Each rivet 25 has a screw hole 26 and an engaging surface 27. Each rivet 25 passes through the through hole 23 of the connecting element 20, the through hole 12 of the plastic base 10, and the through hole 18 of the metal sheath 15 and is then fixed by way of riveting. A rear section of each screw element 28 has an external thread screwed to the screw hole 26 of the rivet 25. A front section of each screw element 28 has a screw hole 29, and a front end of the screw element 28 is flush with the projection 17 of the metal sheath 15.

In the conventional structure, the rivet 25 rivets the metal sheath 15 and the connecting element 20 to the plastic base 10. Meanwhile, the metal sheath 15 is electrically connected to the connecting element 20 through the rivet 25 to achieve the grounding effect. Finally, the screw element 28 is screwed to be flush with the projection 17 of the metal sheath 15. Thus, the manufacturing time is long, and the manufacturing cost is high.

### SUMMARY OF THE INVENTION

It is therefore an object of the invention to provide an electrical connector with a metal sheath, wherein a screw hole member is adopted so that the manufacturing processes are simplified, and the manufacturing cost is reduced.

The invention achieves the above-identified object by providing an electrical connector including a plastic base, a plurality of terminals, a metal sheath, at least one screw hole member and at least one connecting element. The plastic base is formed with a plurality of terminal slots. The terminals are respectively disposed in the terminal slots of the plastic base. The metal sheath has two lateral planes and a middle projection and is disposed at one end of the plastic base. The screw hole member is disposed on one side of the plastic base, is connected to one of the lateral planes of the metal sheath, and has a first plate and a second plate. A surface of the first plate is disposed at one end of the plastic base, a middle of the first plate is formed with a screw hole, and the second plate is integrally connected to one end of the first plate and extends toward the other end of the plastic base. The connecting element has a bottom end formed with a connection portion, and a top end connected to the second plate of the screw hole member.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a pictorially assembled view showing a conventional electrical connector having a metal sheath.

FIG. 2 is a pictorially exploded view showing the conventional electrical connector having the metal sheath.

FIG. 3 is a pictorial view showing a first embodiment of the invention.

FIG. 4 is a pictorial view showing the first embodiment of the invention.

FIG. 5 is a pictorially exploded view showing the first embodiment of the invention.

FIG. 6 is a pictorially exploded view showing a second embodiment of the invention.

FIG. 7 is a pictorially exploded view showing a third embodiment of the invention.

FIG. 8 is a pictorial view showing a fourth embodiment of the invention.

FIG. 9 is a pictorial view showing the fourth embodiment of the invention.

FIG. 10 is a pictorially exploded view showing the fourth embodiment of the invention.

FIG. 11 is a pictorial view showing a fifth embodiment of the invention.

FIG. 12 is a pictorially exploded rear view showing the fifth embodiment of the invention.

FIG. 13 is a pictorially exploded front view showing the fifth embodiment of the invention.

FIG. 14 is a pictorial view showing a sixth embodiment of the invention.

FIG. 15 is a pictorially exploded view showing the sixth embodiment of the invention.

FIG. 16 is a pictorially exploded view showing a seventh embodiment of the invention.

FIG. 17 is a pictorial view showing an eighth embodiment of the invention.

FIG. 18 is a pictorially exploded view showing the eighth embodiment of the invention.

FIG. 19 is a pictorial view showing a ninth embodiment of the invention.

FIG. 20 is a pictorially exploded view showing the ninth embodiment of the invention.

FIG. 21 is a pictorial view showing a tenth embodiment of the invention.

FIG. 22 is a pictorially exploded view showing the tenth embodiment of the invention.

FIG. 23 is a pictorial view showing an eleventh embodiment of the invention.

FIG. 24 is a pictorially exploded view showing a twelfth embodiment of the invention.

FIG. 25 is a pictorially assembled view showing the twelfth embodiment of the invention.

FIG. 26 is a cross-sectional side view showing the twelfth embodiment of the invention.

FIG. 27 is a pictorially exploded view showing a thirteenth embodiment of the invention.

FIG. 28 is a pictorially assembled view showing the thirteenth embodiment of the invention.

FIG. 29 is a pictorially exploded view showing a fourteenth embodiment of the invention.

FIG. 30 is a cross-sectional side view showing the fourteenth embodiment of the invention.

FIG. 31 is a cross-sectional side view showing a fifteenth embodiment of the invention.

FIG. 32 is a pictorially exploded view showing a sixteenth embodiment of the invention.

FIG. 33 is a pictorially exploded view showing a seventeenth embodiment of the invention.

FIG. 34 is a pictorially exploded view showing an eighteenth embodiment of the invention.

FIG. 35 is a pictorially assembled view showing the eighteenth embodiment of the invention.

FIG. 36 is a pictorially exploded view showing a nineteenth embodiment of the invention.

FIG. 37 is a pictorially assembled view showing a twentieth embodiment of the invention.

FIG. 38 is a pictorially exploded view showing a 21^{st} embodiment of the invention.

FIG. 39 is a pictorially assembled view showing the 21^{st} embodiment of the invention.

FIG. 40 is a pictorially exploded view showing a 22^{nd} embodiment of the invention.

FIG. 41 is a pictorially assembled view showing the 22^{nd} embodiment of the invention.

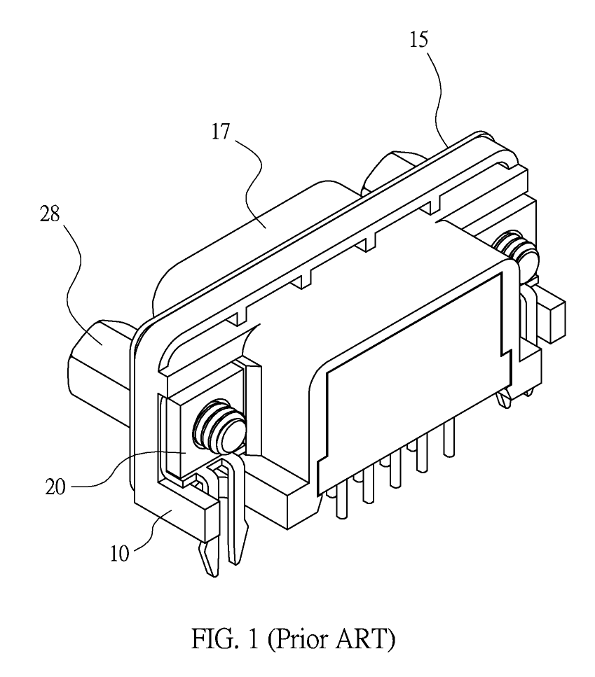

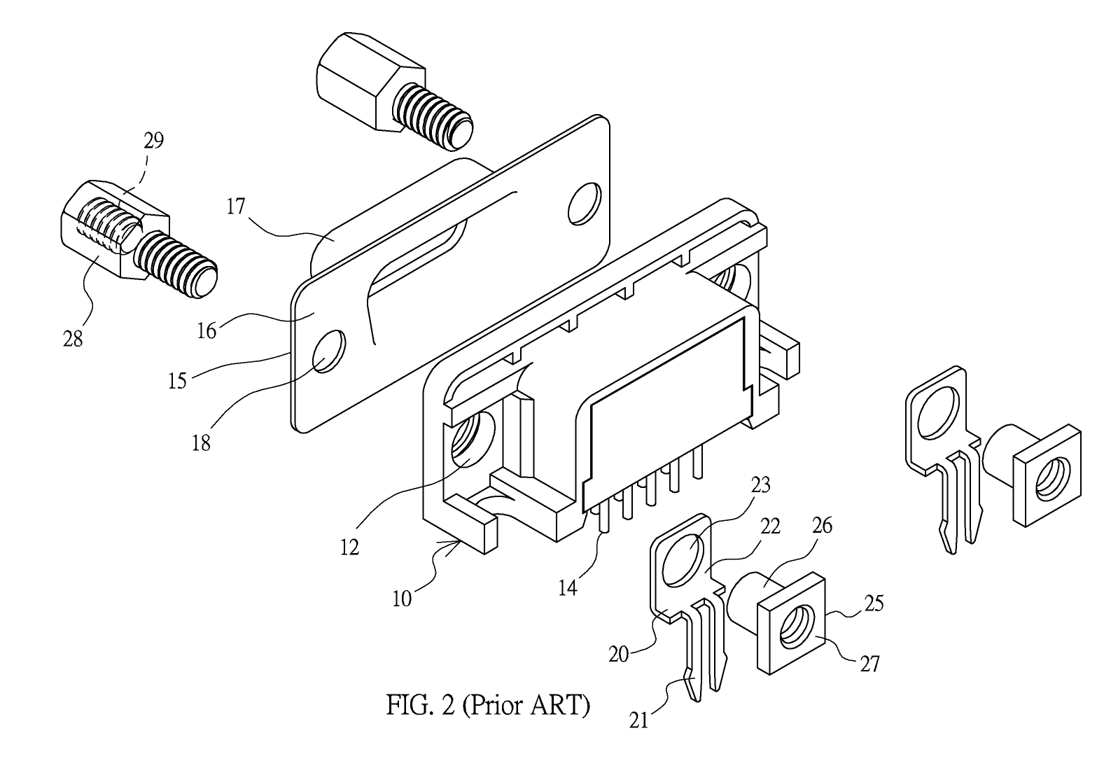

### DETAILED DESCRIPTION OF THE INVENTION

The present invention will be apparent from the following detailed description, which proceeds with reference to the accompanying drawings, wherein the same references relate to the same elements.

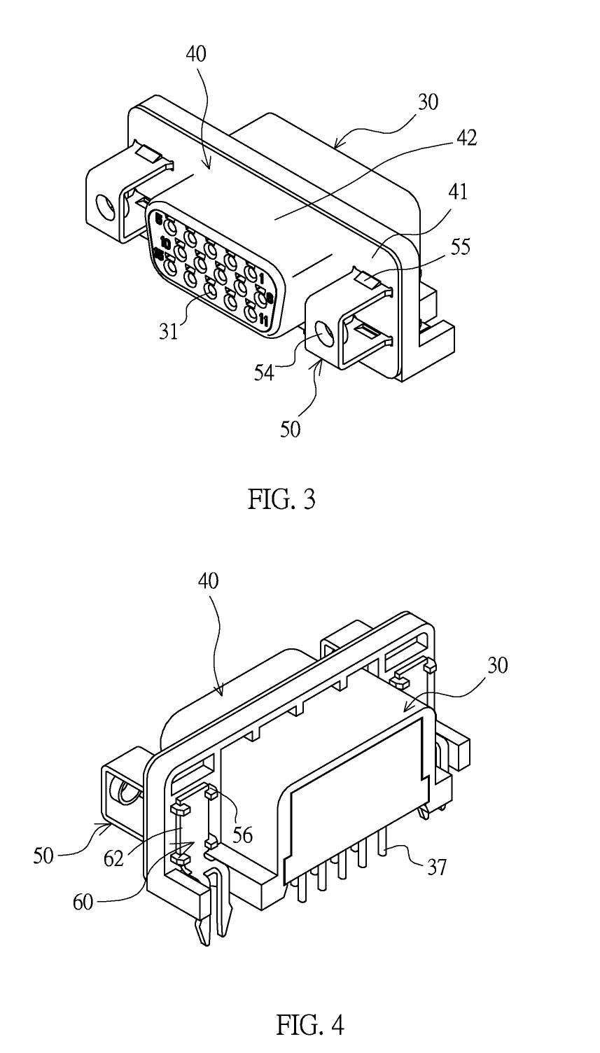

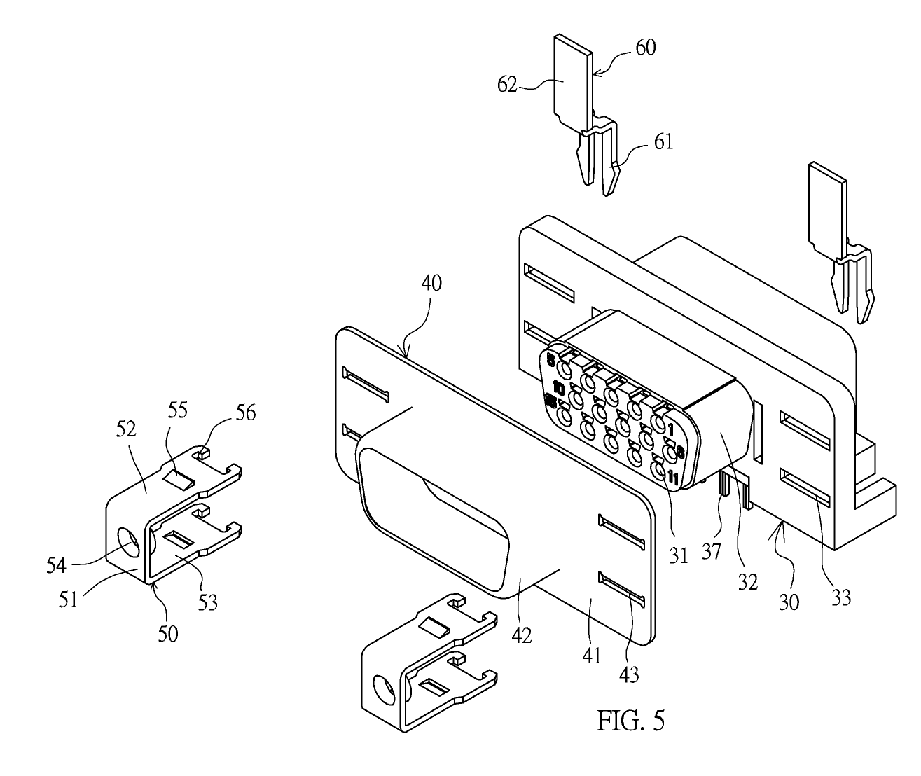

Referring to FIGS. 3 to 5, a D-SUB electrical connector having a connection portion facing frontward according to the first embodiment of the invention includes a plastic base 30, a plurality of terminals 37, a metal sheath 40, two screw hole members 50 and two connecting elements 60.

The plastic base 30 is formed with a plurality of terminal slots 31. A front end of the plastic base 30 has a projection 32. Two sides of the terminal slots 31 are respectively formed with two transversal long slots 33.

The terminals 37 are respectively disposed in the terminal slots 31 of the plastic base 30. A pin of the terminal 37 extends out of the plastic base 30.

The metal sheath 40 is disposed at the front end of the plastic base 30, and has two lateral planes 41 and one middle projection 42. The projection 42 covers the periphery of the projection 32 of the plastic base 30. Each of the two lateral planes 41 is formed with two transversal long slots 43.

The two screw hole members 50 are disposed on two sides of the plastic base 30. The screw hole member 50 is connected to one of the lateral planes 41 of the metal sheath 40, and has a longitudinal first plate 51 and transversal second and third plates 52 and 53. A screw hole 54 is formed at the middle of the first plate 51. The second and third plates 52 and 53 are integrally connected to the top and bottom ends of the first plate 51. The surfaces of the plates 52 and 53 are transversal and extend to the rear side of the plastic base 30 in parallel. Each of the second and third plates 52 and 53 is formed with an engaging block 55 projecting out of the surface thereof, and is formed with a slot 56 at an outer end thereof.

The two connecting elements 60, which are to be connected to a circuit board and thus grounded, are disposed on two sides of the rear side of the plastic base 30. A lower section of the connecting element 60 has a connection portion 61, which is an elastic hook. An upper section of connecting element 60 is formed with an engaging plate 62 engaging with the slots 56 of the second and third plates 52 and 53.

The electrical connector is assembled according to the following steps.

First, the projection 42 of the metal sheath 40 covers the projection 32 of the plastic base 30.

Second, the second and third plates 52 and 53 of the screw hole member 50 pass through the two transversal long slots 43 of the metal sheath 40 and the two transversal long slots 33 of the plastic base 30, and are stopped at the planes 41 of the metal sheath 40 through the engaging blocks 55. At this time, the first plate 51 of the screw hole member 50 is substantially flush with the projection 42 of the metal sheath 40, and the outer ends of the second and third plates 52 and 53 have extended to the rear side of the plastic base 30.

Third, the engaging plate 62 of the connecting element 60 engages with the slots 56 of the second and third plates 52 and 53. Thus, the screw hole member 50, the metal sheath 40 and the connecting element 60 may be fixed to the plastic base 30.

According to the above-mentioned description, it is obtained that the invention may be assembled through the simple engagement without the need of the riveting machine and without the need of two screw elements. The screw hole member 50 is substantially flush with the projection 42 of the metal sheath 40 in this invention to achieve the function equivalent to that of the conventional screw elements. So, the manufacturing cost can be significantly decreased.

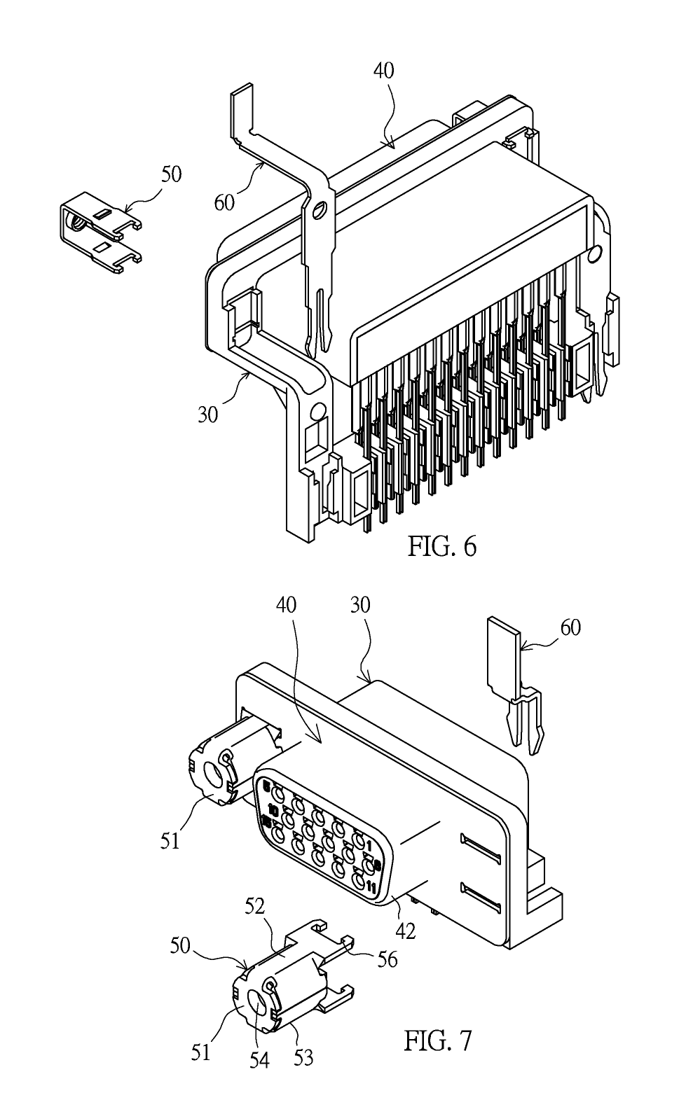

As shown in FIG. 6, the second embodiment of the invention is almost the same as the first embodiment except that the plastic base 30 of the second embodiment is raised, and the two connecting elements 60 are also raised correspondingly.

As shown in FIG. 7, the third embodiment of the invention is almost the same as the first embodiment except that the screw hole member 50 of the third embodiment is a plate-like material, which is bent into a circle to form a hollow cylinder. Similarly, the screw hole member 50 also has first, second and third plates 51, 52 and 53. The first plate 51 is circular and is formed with a screw hole 54 at the middle thereof. Two sides of the second plate 52 are bent downwards to form arcs. Two sides of the third plate 53 are bent upwards to form arcs. Each of the outer ends of the second and third plates 52 and 53 is formed with a slot 56. The first plate 51 of the screw hole member 50 is substantially flush with the projection 42 of the metal sheath 40.

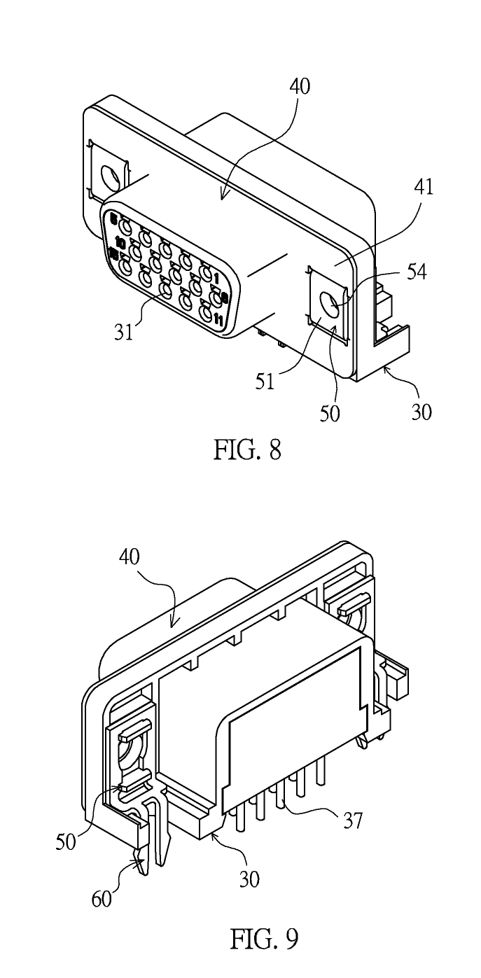

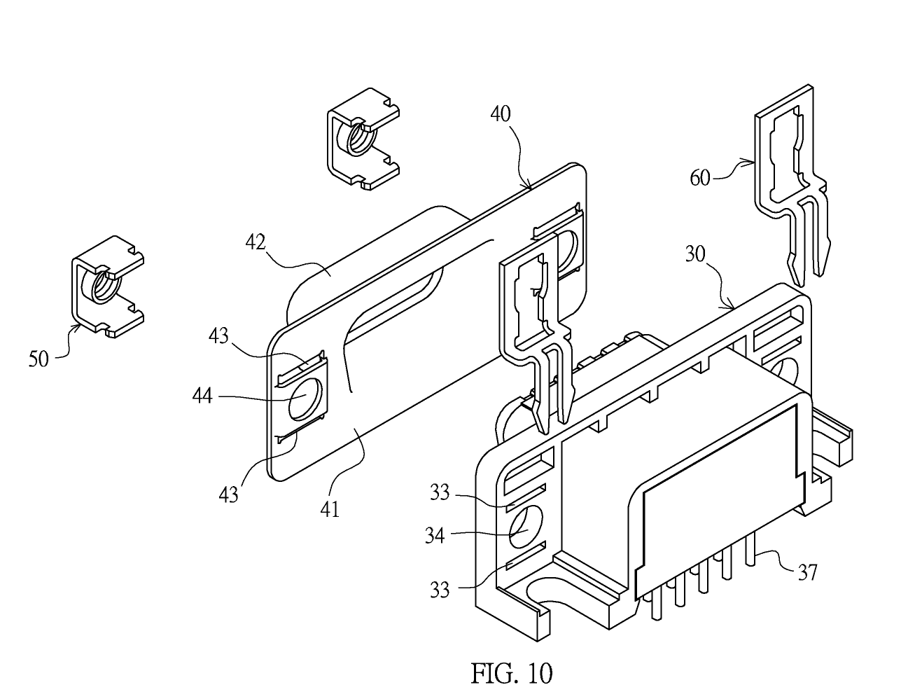

As shown in FIGS. 8 to 10, the fourth embodiment of the invention is almost the same as the first embodiment. The connector of the fourth embodiment includes a plastic base 30, terminals 37, a metal sheath 40, two screw hole members 50 and two connecting elements 60. The differences between the fourth and first embodiments will be described in the following. A circular hole 44 is further formed between two transversal long slots 43 on two lateral planes 41 of the metal sheath 40, and a circular hole 34 is further formed between two transversal long slots 33 on two sides of the plastic base 30. The screw hole member 50 is shorter than the first embodiment. After the assembly, the first plate 51 is in surface contact with one of the lateral planes 41 of the metal sheath 40.

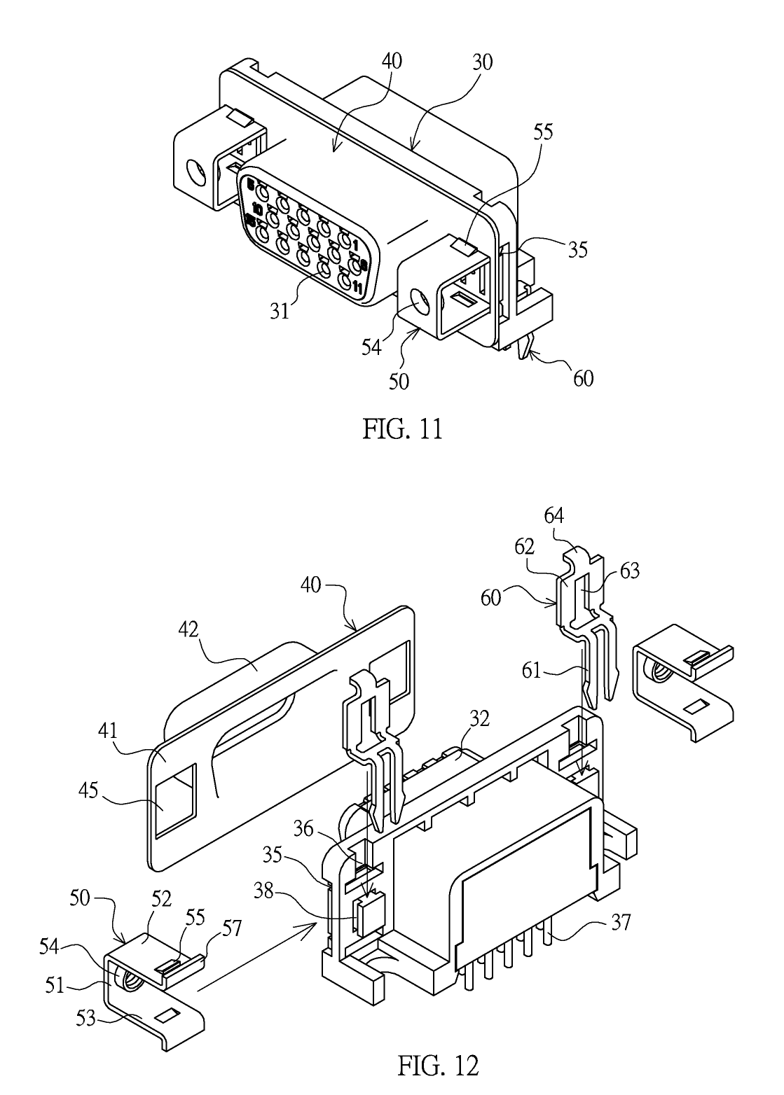

As shown in FIGS. 11 to 13, the fifth embodiment of the invention is almost the same as the first embodiment. The connector of the fifth embodiment includes a plastic base 30, terminals 37, a metal sheath 40, two screw hole members 50 and two connecting elements 60.

Multiple terminal slots 31 are formed in the plastic base 30. The front end of the plastic base 30 is formed with a projection 32, each of two sides of the plastic base 30 is formed with a transversal slot 35, and each of two sides of the rear side of the plastic base 30 is formed with an opening 36 and a longitudinal slot 38, wherein the opening 36 corresponds to the transversal slot 35.

The terminals 37 are disposed in the terminal slots 31 of the plastic base 30, and the pins of the terminals 37 extend out of the plastic base 30.

The screw hole member 50 has a longitudinal first plate 51 and transversal second and third plates 52 and 53. The middle of the first plate 51 is formed with a screw hole 54. The second and third plates 52 and 53 are integrally connected to the top and bottom ends of the first plate 51, and the surfaces thereof extend transversally and in parallel. Each of the second and third plates 52 and 53 is formed with an engaging block 55 projecting out of the surface, and each of the outer ends of the second and third plates 52 and 53 is formed with an engaging edge 57 projecting out of the surface. The engaging edges 57 of the second and third plates of the screw hole member 50 may engage with the transversal slots 35 laterally. The engaging edge 57 of the second plate 52 is exposed from the opening 36.

The metal sheath 40 is disposed at the front end of the plastic base 30, and has two lateral planes 41 and one middle projection 42. The projection 42 covers the periphery of the projection 32 of the plastic base 30, and each of the two lateral planes 41 is formed with an opening 45. When the metal sheath 40 covers the front end of the plastic base 30, the first plate 51 of the screw hole member 50 is inserted into the opening 45, and the engaging blocks 55 of the second and third plates engage with the two lateral planes 41 of the metal sheath 40, wherein the first plate 51 of the screw hole member 50 is substantially flush with the projection 42 of the metal sheath 40.

The lower section of the connecting element 60 is formed with a connection portion 61, which is an elastic hook. The upper section of the connecting element 60 is formed with an engaging plate 62, which is formed with a slot 63 engaging with the longitudinal slot 38 of the rear side of the plastic base 30. The top end of the engaging plate 62 is formed with a tab 64 extending into the opening 36 and connected to the engaging edge 57 of the second plate 52.

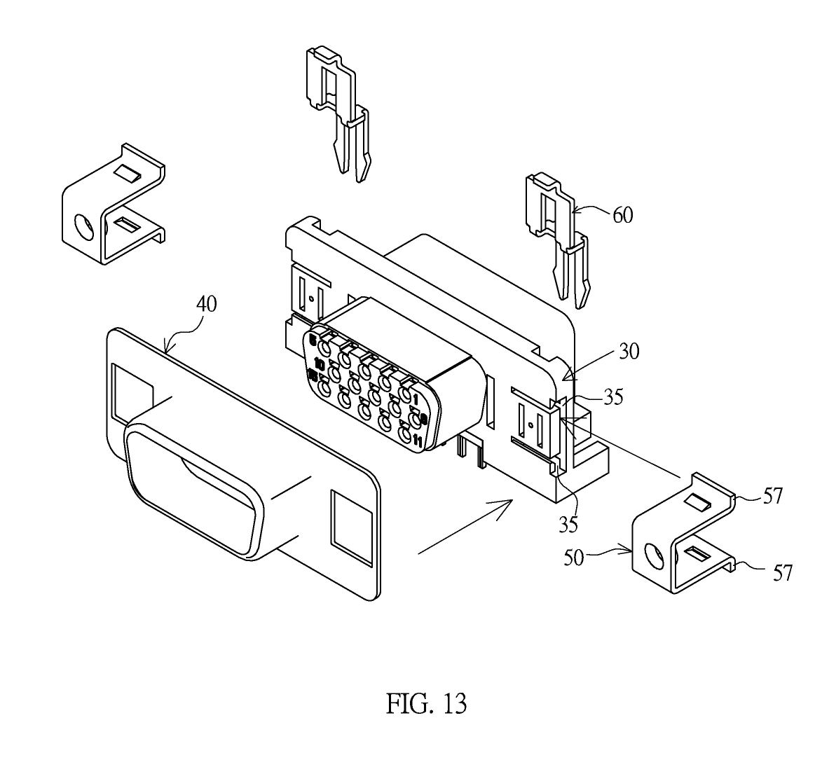

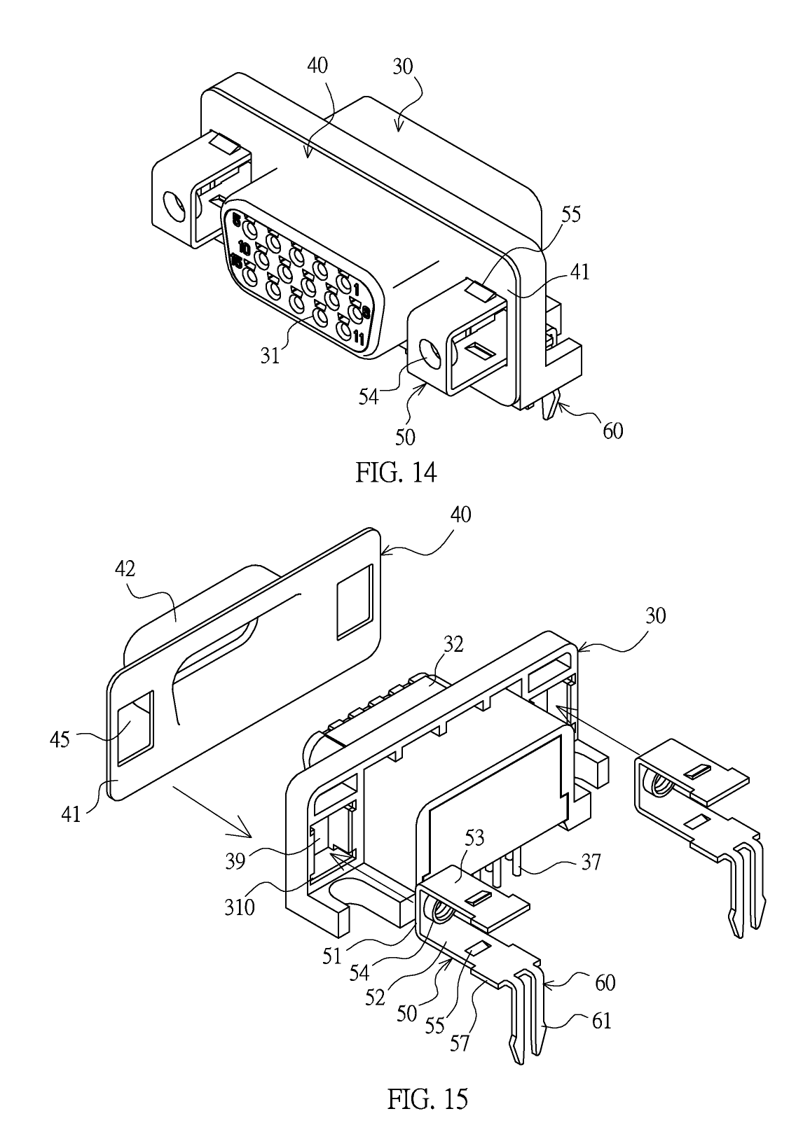

As shown in FIGS. 14 and 15, the fifth embodiment of the invention is almost the same as the first embodiment. The connector of the fifth embodiment includes a plastic base 30, terminals 37, a metal sheath 40, two screw hole members 50 and two connecting elements 60.

The plastic base 30 is formed with multiple terminal slots 31, and has a front end formed with a projection 32 and two sides each formed with an opening 39. A transversal slot 310 is formed on each of the top and bottom of the rear end of the opening 39.

The terminals 37 are disposed in the terminal slots 31 of the plastic base 30 and the pins of the terminals 37 extend out of the plastic base 30.

The metal sheath 40 disposed at the front end of the plastic base 30 has two lateral planes 41 and one middle projection 42. The projection 42 of the metal sheath 40 covers the periphery of the projection 32 of the plastic base 30, and each of the two lateral planes 41 is formed with an opening 45 corresponding to the opening 39 of the plastic base 30.

The screw hole member 50 has a longitudinal first plate 51 and transversal second and third plates 52 and 53. The middle of the first plate 51 is formed with a screw hole 54. The second and third plates 52 and 53 are integrally connected to the bottom and top ends of the first plate 51, and have surfaces extending transversally and in parallel to each other. Each of the second and third plates 52 and 53 is formed with an engaging block 55 projecting out of the surface thereof, and has an outer end formed with a lateral engaging edge 57.

The connecting element 60 is integrally connected to the second plate 52 of the screw hole member 50 and has a lower section formed with a connection portion 61, which is an elastic hook.

During assembling, the projection 42 of the metal sheath 40 firstly covers the projection 32 of the plastic base 30, and the screw hole member 50 then passes through the opening 39 of the plastic base and the opening 45 of the metal sheath 40 from the rear side of the plastic base 30. The engaging blocks 55 of the second and third plates 52 and 53 engage with one of the lateral planes 41 of the metal sheath 40, and the engaging edge 57 engages with the transversal slot 310 of the plastic base 30, wherein the first plate 51 of the screw hole member 50 is substantially flush with the projection 42 of the metal sheath 40.

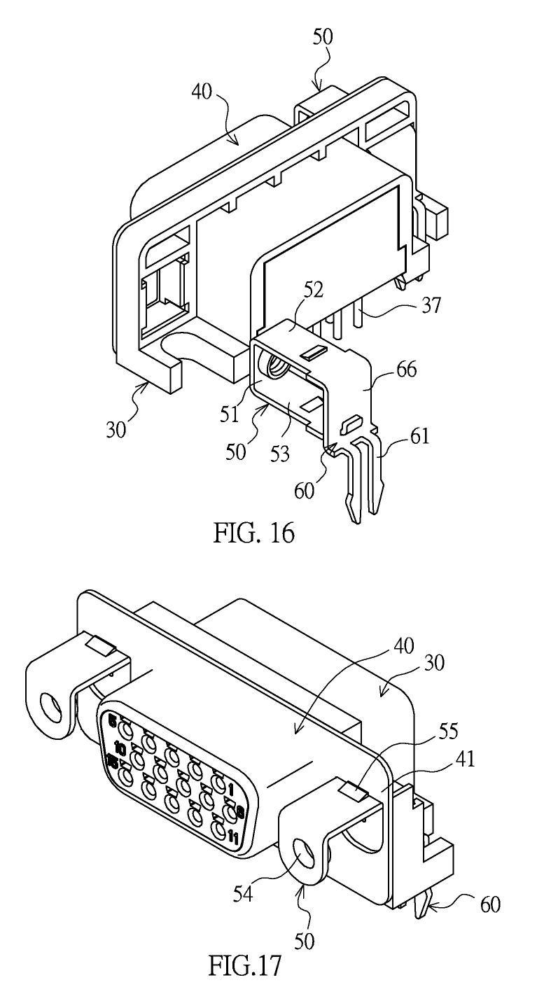

As shown in FIG. 16, the seventh embodiment of the invention is almost the same as the sixth embodiment. The connector of the seventh embodiment includes a plastic base 30, multiple terminals 37, a metal sheath 40, two screw hole members 50 and two connecting elements 60. The differences between the seventh and sixth embodiments are listed in the following. The top and bottom ends of the first plate 51 of the screw hole member 50 are integrally connected to the second and third plates 52 and 53. The upper section of the connecting element 60 is formed with a connecting plate 66, which is integrally connected to the second plate 52 of the screw hole member 50. The outer end of the third plate 53 hooks the connecting plate 66.

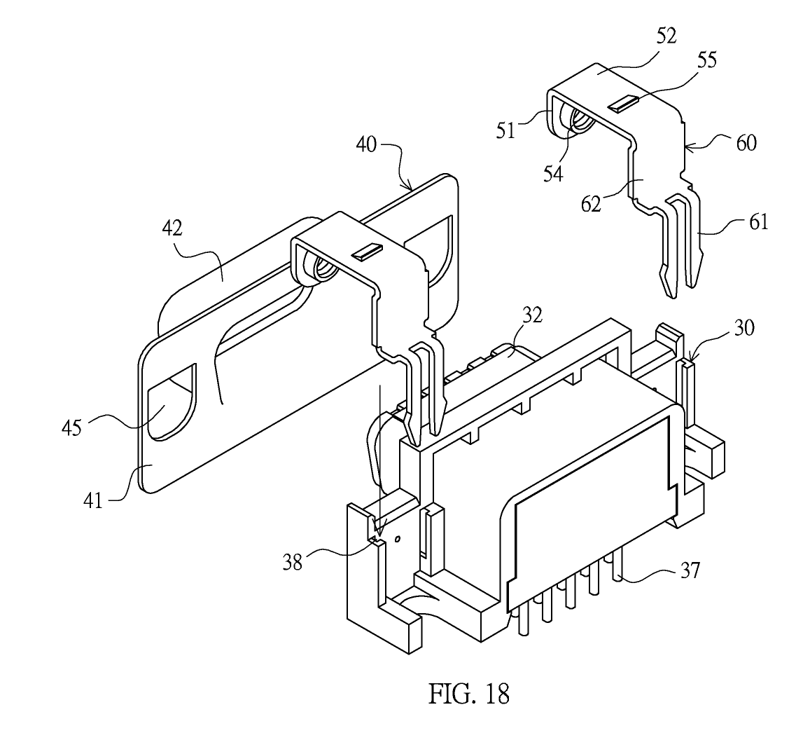

As shown in FIGS. 17 and 18, the eighth embodiment of the invention is almost the same as the first embodiment. The connector of the eighth embodiment includes a plastic base 30, multiple terminals 37, a metal sheath 40, two screw hole members 50 and two connecting elements 60.

The plastic base 30 is formed with multiple terminal slots 31 and has a front end formed with a projection 32, and two sides each formed with a longitudinal slot 38 at a rear side.

The terminals 37 are disposed in the terminal slots 31 of the plastic base 30, and the pins of the terminals 37 extend out of the plastic base 30.

The metal sheath 40 disposed at the front end of the plastic base 30 has two lateral planes 41 and a middle projection 42. The projection 42 covers the periphery of the projection 32 of the plastic base 30, and each of the two lateral planes 41 is formed with an opening 45.

The screw hole member 50 has a longitudinal first plate 51 and a transversal second plate 52. The middle of the first plate 51 is formed with a screw hole 54. The second plate 52 is integrally connected to the top end of the first plate 51 and transversally extends to the rear side of the plastic base 30. The second plate 52 has an engaging block 55 projecting out of its surface.

The connecting element 60 is integrally connected to the second plate 52 of the screw hole member 50, has a lower section formed with a connection portion 61, which is an elastic hook, and also has an upper section formed with an engaging plate 62.

During assembling, the screw hole member 50 and the connecting element 60, which are integrally connected together, are assembled and positioned, from top to bottom, to the plastic base 30, and the engaging plate 62 engages with the longitudinal slot 38 of the plastic base 30. When the metal sheath 40 covers the front end of the plastic base 30, the first plate 51 of the screw hole member 50 is inserted into the opening 45, and the engaging block 55 of the second plate 52 engages with two lateral planes 41 of the metal sheath 40.

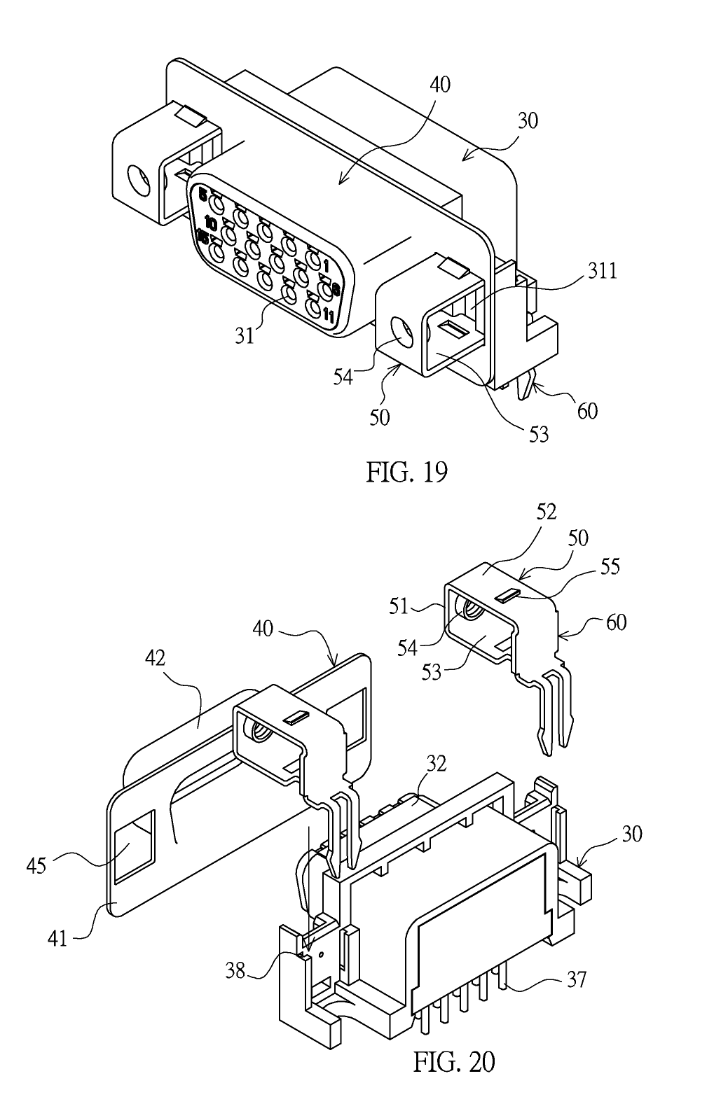

As shown in FIGS. 19 and 20, the ninth embodiment of the invention is almost the same as the eighth embodiment. The connector of the ninth embodiment includes a plastic base 30, multiple terminals 37, a metal sheath 40, two screw hole members 50 and two connecting elements 60. The differences between the ninth and eighth embodiments are listed in the following. The bottom end of the first plate 51 of the screw hole member 50 is integrally connected to a third plate 53 parallel to the second plate 52. Each of two sides of the front end of the plastic base 30 is formed with a slot 311. The outer end of the third plate 53 of the screw hole member 50 engages with the slot 311.

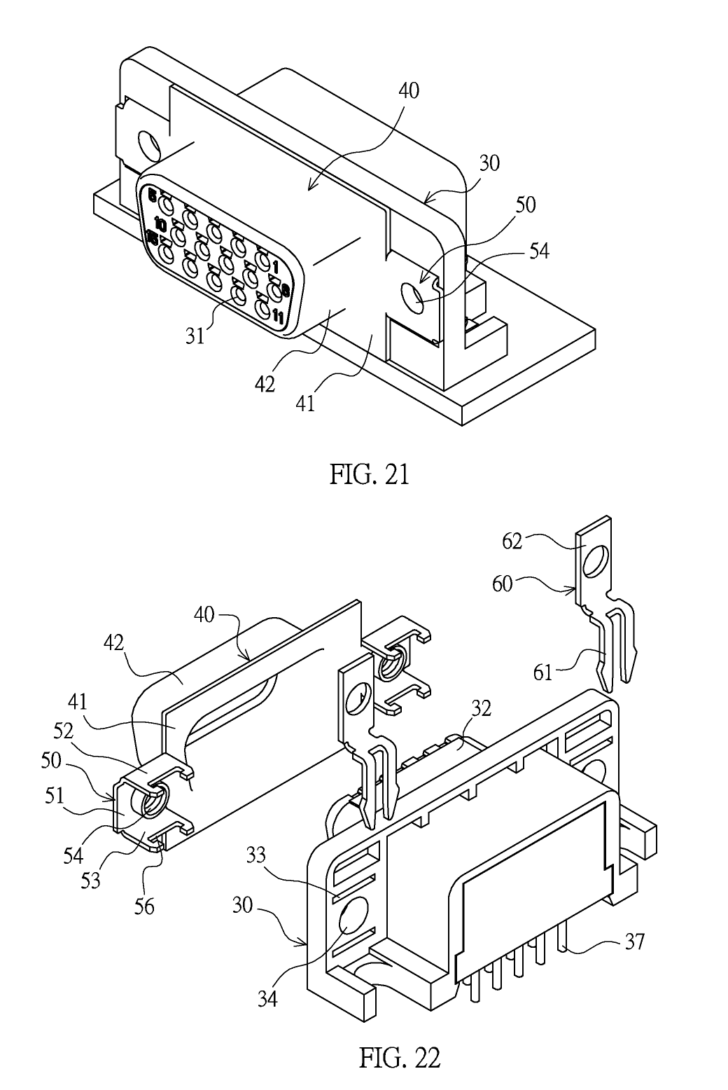

As shown in FIGS. 21 and 22, the tenth embodiment of the invention is almost the same as the fourth embodiment. The connector of the tenth embodiment includes a plastic base 30, multiple terminals 37, a metal sheath 40, two screw hole members 50 and two connecting elements 60. The difference between the tenth and fourth embodiments resides in that the screw hole member 50 of the tenth embodiment is integrally connected to the plane 41 on one side of the metal sheath 40.

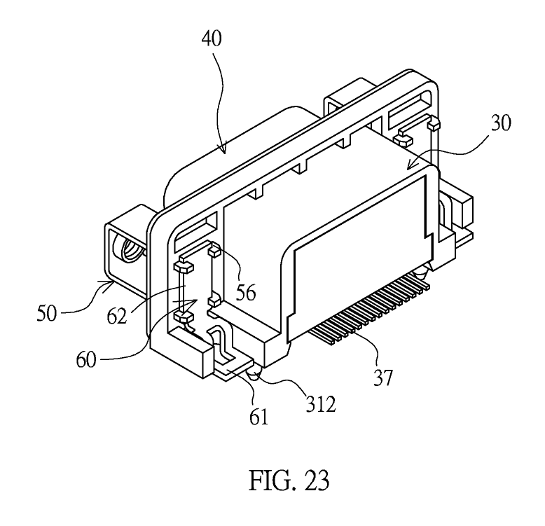

As shown in FIG. 23, the eleventh embodiment of the invention is almost the same as the first embodiment except that the connection portion 61 of the connecting element 60 of the eleventh embodiment is a horizontal plate, that the pin of each terminal 37 extending out of the plastic base 30 is horizontal, and that the bottom of the plastic base 30 is formed with several engaging posts 312.

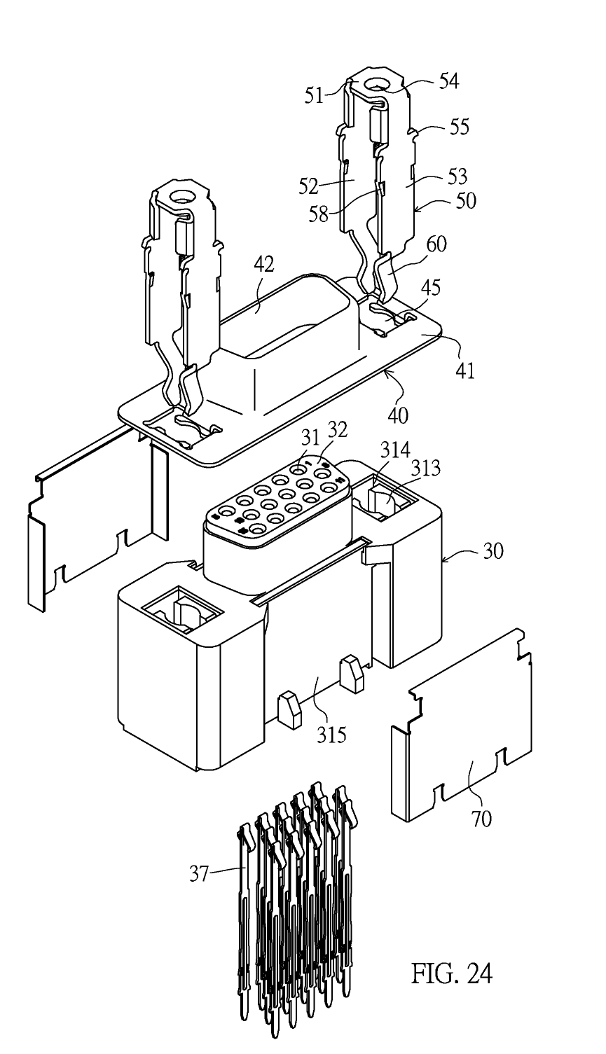

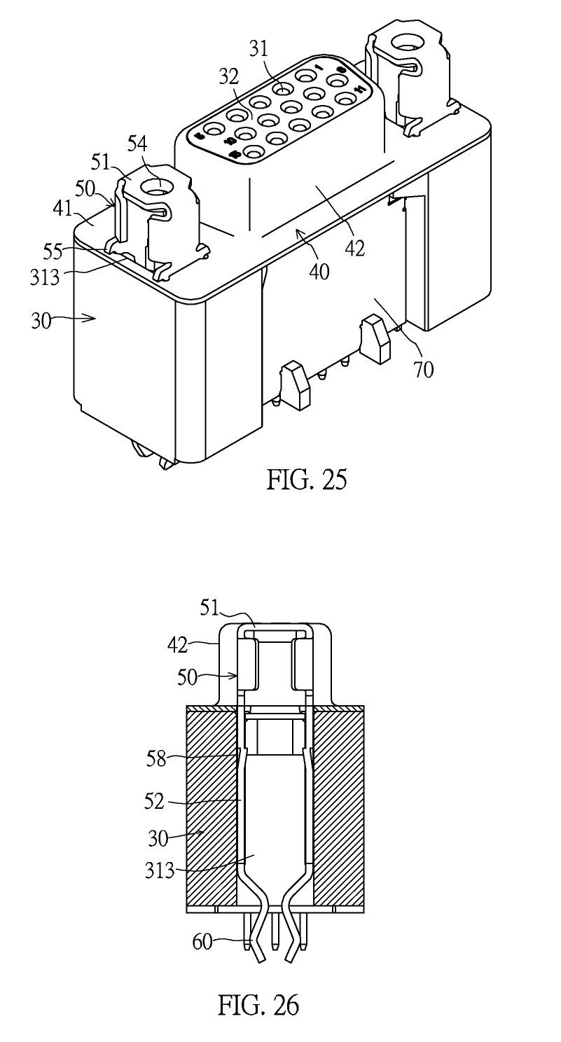

As shown in FIGS. 24 to 26, the connector according to the twelfth embodiment of the invention is a vertical D-SUB electrical connector, which includes a plastic base 30, multiple terminals 37, a metal sheath 40, two screw hole members 50, two connecting elements 60 and two metal sheets 70.

The plastic base 30 is formed with multiple terminal slots 31, and has a top end formed with a projection 32 and two sides each formed with a longitudinal through hole 313. Each of two opposite sides of the longitudinal through hole 313 is formed with one slot 314. Each of the front and rear sides of the plastic base corresponding to the lower portion of the projection 32 is formed with a concave surface 315.

The terminals 37 are respectively disposed in the terminal slots 31 of the plastic base 30, and the pins of the terminals 37 extend out of the plastic base 30.

The metal sheath 40 disposed on the top end of the plastic base 30 has two lateral planes 41 and one middle projection 42. The projection 42 covers the periphery of the projection 32 of the plastic base 30, and each of the two lateral planes 41 is formed with one opening 45.

The two screw hole members 50 are disposed on two sides of the plastic base 30 and are respectively to the lateral planes 41 of the metal sheath 40. The screw hole member 50 has a transversal first plate 51 and longitudinal second and third plates 52 and 53. The middle of the first plate 51 is formed with a screw hole 54. The second and third plates 52 and 53 are integrally connected to two opposite sides of the first plate 51, and have longitudinal surfaces extending toward the bottom end of the plastic base 30. Each of two sides of the upper sections of the second and third plates 52 and 53 is formed with a laterally projecting engaging block 55, and each of two sides of the middle sections of the second and third plates 52 and 53 is formed with a fixing portion 58 projecting from the surface thereof.

The connecting element 60 includes two elastic engaging sheets, which are respectively and integrally connected to the bottom ends of the second and third plates 52 and 53.

The two metal sheets 70 are disposed on the concave surfaces 58 at the front and rear sides of the plastic base 30 such that the positions of the plastic base 30 where the terminals are disposed have the better shielding effects.

The connector is assembled according to the following steps.

First, the projection 42 of the metal sheath 40 covers the projection 32 of the plastic base 30.

Second, the second and third plates 52 and 53 of the two screw hole members 50 pass through the openings 45 on two sides of the metal sheath 40 and the longitudinal through holes 313 on two sides of the plastic base 30, and the engaging block 55 presses against the plane 41 of the metal sheath 40. At this time, the first plate 51 of the screw hole member 50 is substantially flush with the projection 42 of the metal sheath 40, the fixing portions 58 of the second and third plates 52 and 53 engage with the slots 314 of the plastic base 30, and the connecting element 60 extends out of the bottom end of the plastic base 30.

As shown in FIGS. 27 and 28, the thirteenth embodiment of the invention is almost the same as the twelfth embodiment except that the two screw hole members 50 of the thirteenth embodiment are shorter, and the second and third plates 52 and 53 are not formed with engaging blocks. So, the first plate 51 is in surface contact with the concave surface 46 of the metal sheath 40 and is thus flush with the plane 41.

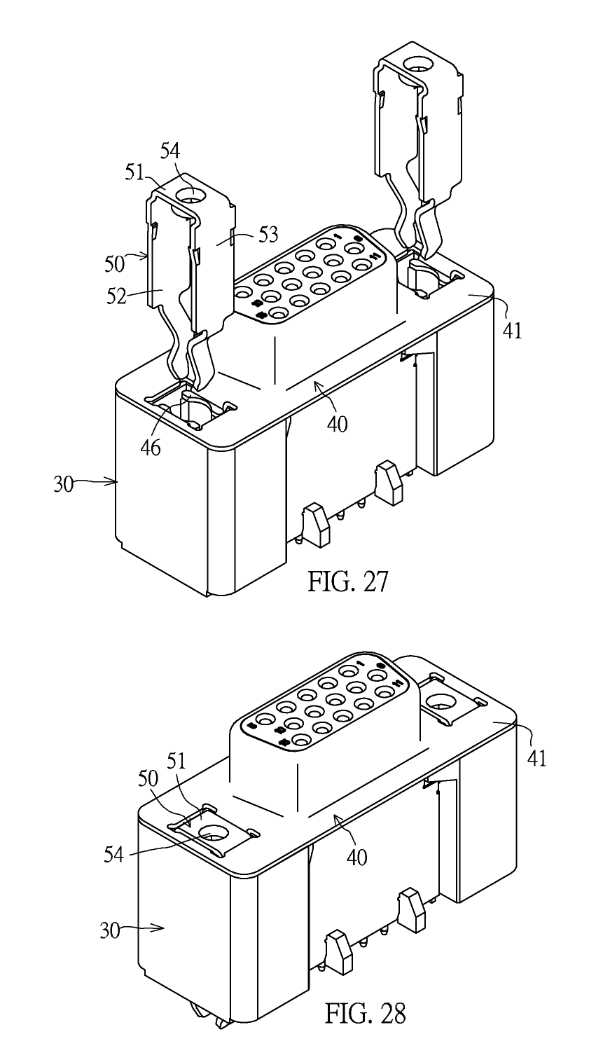

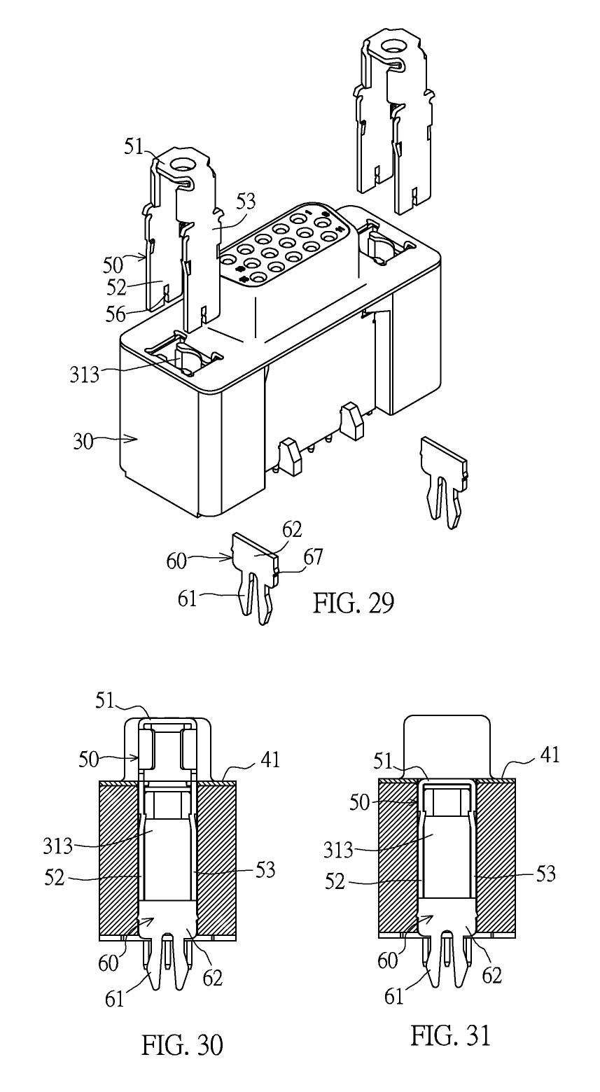

As shown in FIGS. 29 and 30, the fourteenth embodiment of the invention is almost the same as the twelfth embodiment except that the two screw hole members 50 and the connecting element 60 are not integrally formed in the fourteenth embodiment. Each of the bottom ends of the second and third plates 52 and 53 is formed with a slot 56. The middle of the slot 56 is formed with a bottleneck. The connecting element 60 has an engaging plate 62 and a connection portion 61. Each of two sides of the engaging plate 62 is formed with a barb 67, which is assembled to and engages with the slot 56 of the bottom end of the second and third plates. The connection portion 61 is a fork-like elastic hook.

As shown in FIG. 31, the fifteenth embodiment of the invention is almost the same as the fourteenth embodiment except that the screw hole member 50 of the fifteenth embodiment is shorter, and that the first plate 51 of the screw hole member 50 is flush with the plane 41 of the metal sheath 40.

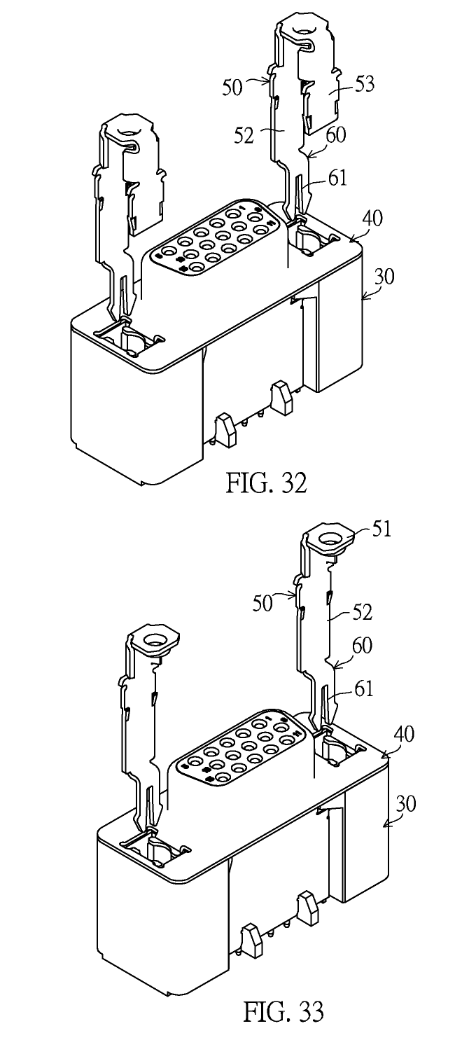

As shown in FIG. 32, the sixteenth embodiment of the invention is almost the same as the twelfth embodiment except that the top end of the connecting element 60 of the sixteenth embodiment is integrally connected to the bottom end of the second plate 52 of the screw hole member 50. The connection portion 61 is a fork-like elastic hook.

As shown in FIG. 33, the seventeenth embodiment of the invention is almost the same as the sixteenth embodiment except that the screw hole member 50 of the seventeenth embodiment only has one transversal first plate 51 and one longitudinal second plate 52, and has no third plate.

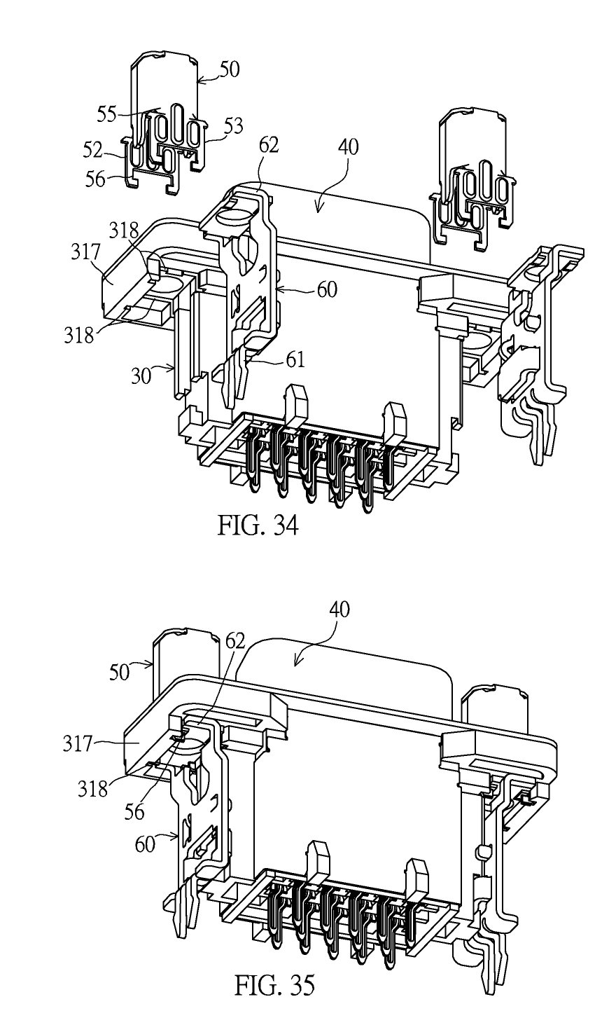

As shown in FIGS. 34 and 35, the thirteenth embodiment of the invention is almost the same as the twelfth embodiment except that the thickness of each of two lateral portions 317 of the plastic base 30 is thinner than that of the middle portion of the plastic base 30. Each of the two lateral portions 317 is formed with two longitudinal slots 318. Each of the bottom ends of the second and third plates 52 and 53 of the screw hole member 50 is formed with one slot 56. The lower sections of the second and third plates 52 and 53 pass through the two longitudinal slots 318. The engaging block 55 stops at the plane of the metal sheath 40. The connecting element 60 has an engaging plate 62 and a connection portion 61. The engaging plate 62 is transversally assembled to and engages with the slots 56 of the bottom ends of the second and third plates. Thus, the screw hole member 50, the metal sheath 40 and the connecting element 60 may be fixed to the plastic base 30.

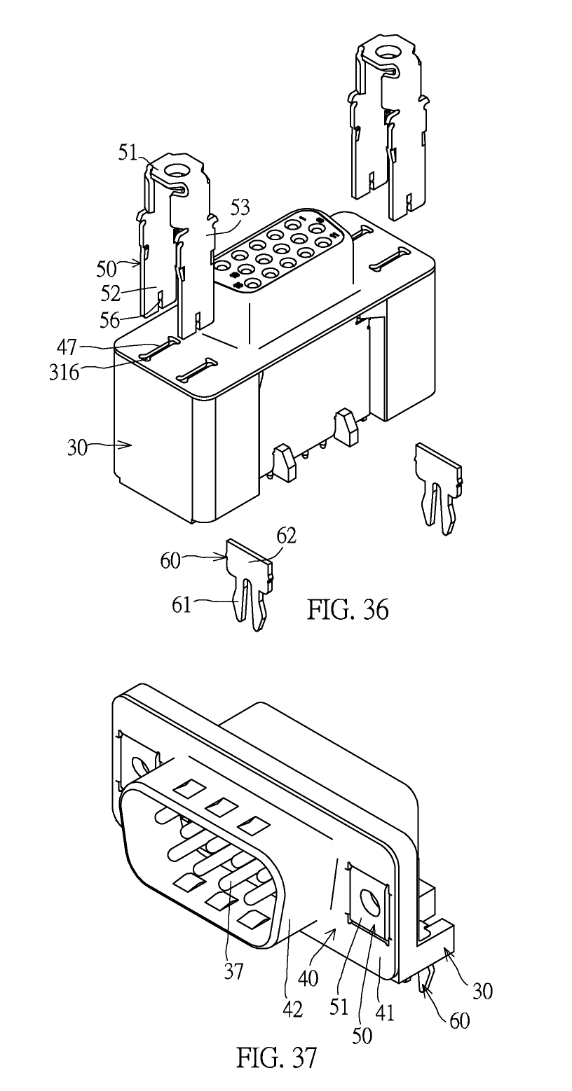

As shown in FIG. 36, the thirteenth embodiment of the invention is almost the same as the twelfth embodiment except that one side of the plastic base 30 of this embodiment is formed with two longitudinal long slots 316, and one side of the metal sheath is formed with two long slots 47 corresponding to the two longitudinal long slots 316. The second and third plates 52 and 53 respectively pass through one of the long slots 47 of the metal sheath and one of the longitudinal long slots 316 of the plastic base.

The embodiments mentioned hereinabove pertain to the female-type electrical connector, wherein one end of the plastic base is formed with a projection, and each terminal is a female-type terminal arranged in the projection. However, the male-type electrical connector may also be implemented according to the invention.

As shown in FIG. 37, a male-type electrical connector according to the twentieth embodiment of the invention is disclose. The front end of the plastic base 30 of this embodiment is not formed with a projection, and each terminal 37 is a male-type terminal having a needle-type contact projecting out of the front end of the plastic base 30. The projection 42 of the metal sheath 40 covers each terminal 37. In the embodiment, the screw hole member 50 is shorter, and the first plate 51 of the screw hole member 50 is flush with the plane 41 of the metal sheath 40.

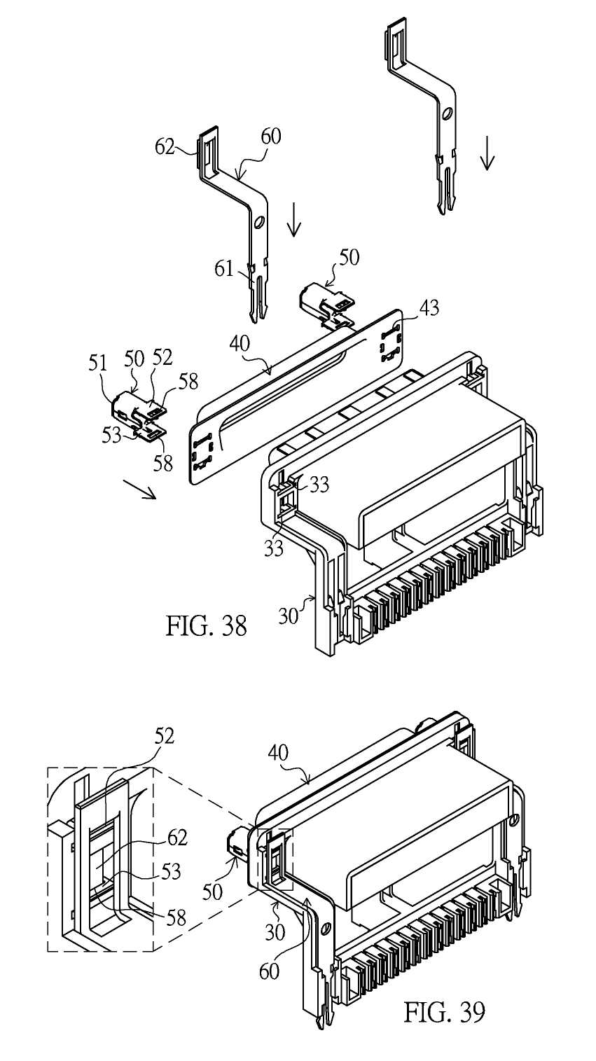

As shown in FIGS. 38 and 39, the 21^{st} embodiment of the invention is almost the same as the third embodiment, wherein two transversal long slots 33 are formed on two sides of the plastic base 30, two transversal long slots 43 are formed on two sides of the metal sheath 40, and the screw hole member 50 is a plate-like material, which is bent into a circle to form a hollow cylinder. The difference therebetween resides in that the plastic base 30 of this embodiment is raised, the two connecting elements 60 are also raised correspondingly, and an each of the outer ends of the second and third plates 52 and 53 of the screw hole member 50 is formed with an engagement hole 58. In this embodiment, the surface of the upper section of the connecting element 60 is pressed to form a projecting engaging plate 62. The engaging plate 62 passes through the engagement holes 58 of the second and third plates 52 and 53 such that the screw hole member 50, the metal sheath 40 and the connecting elements 60 are mounted on the plastic base 30.

In addition, the cylindrical lower edge of the screw hole member 50 of this embodiment is formed with two symmetrical tabs 59 engaging with the plastic base 30 to enhance the stability.

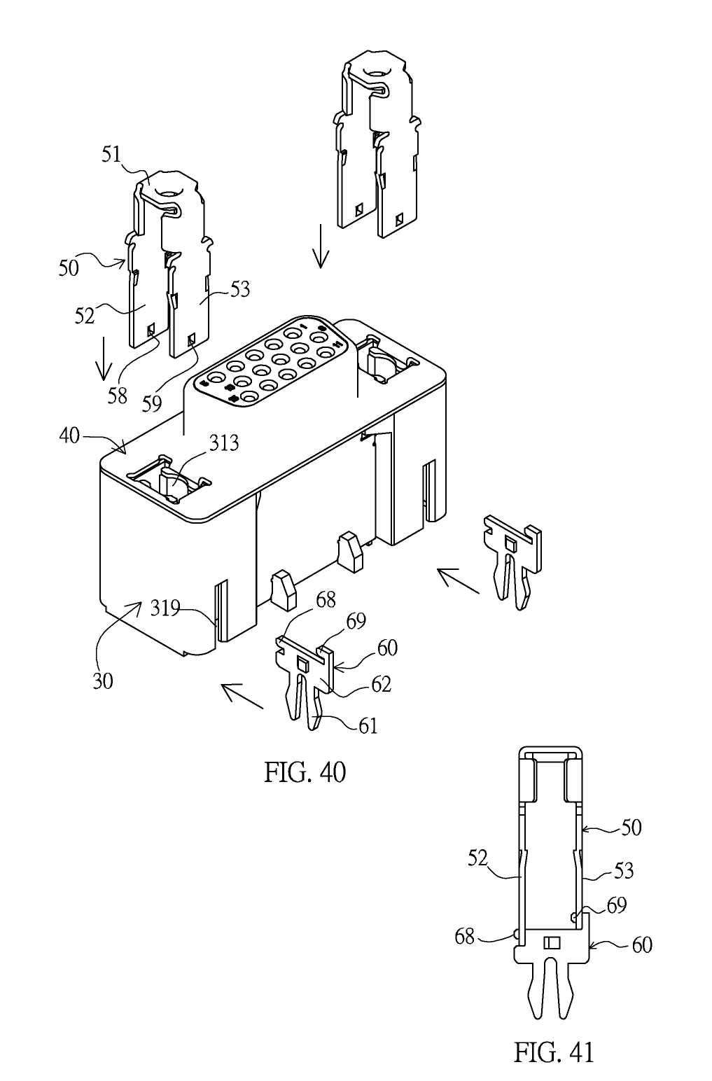

As shown in FIGS. 40 and 41, the 22^{nd} embodiment of the invention is almost the same as the fourteenth embodiment, wherein the bottom ends of the second and third plates 52 and 53 are respectively formed with engagement holes 58 and 59, and the second plate 52 is longer than the third plate 53 such that the engagement hole 58 is lower than the engagement hole 59. The engaging plate 62 of the connecting element 60 is formed with a lower hook 68 and a higher hook 69. Each of portions near two sides of one surface of the plastic base 30 is formed with a longitudinal slot 319, through which the connecting element 60 passes. During the assembling process, the screw hole member 50 firstly passes through the longitudinal through hole 313 of the plastic base 30, and then the two hooks 68 and 69 of the connecting element 60 respectively pass through the engagement holes 58 and 59 of the second and third plates.

In the first to eleventh embodiments and the 21^{st} embodiment, the D-SUB electrical connector has the connection portion facing frontward. In the twelfth to twentieth embodiments and the 22^{nd} embodiment, the vertical D-SUB electrical connector has the connection portion facing upward. So, only the two types of connectors according to several embodiments are disclosed. However, the structure of each of the first to eleventh embodiments and the 21^{st} embodiment may also be applied to the vertical D-SUB electrical connector, and detailed descriptions thereof will be omitted.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An electrical connector, comprising:
a plastic base formed with a plurality of terminal slots;
a plurality of terminals respectively disposed in the terminal slots of the plastic base;
a metal sheath having two lateral planes and a middle projection and disposed at one end of the plastic base;
at least one screw hole member, which is disposed on one side of the plastic base, is connected to one of the lateral planes of the metal sheath, and has a first plate and a second plate, wherein a surface of the first plate is disposed at one end of the plastic base, a middle of the first plate is formed with a screw hole, and the second plate is integrally connected to one end of the first plate and extends toward the other end of the plastic base; and
at least one connecting element having a bottom end formed with a connection portion, and a top end connected to the second plate of the screw hole member.

2. The electrical connector according to claim 1, wherein the surface of the first plate is longitudinal and a surface of the second plate is transversal, the metal sheath is disposed at a front end of the plastic base, the first plate is disposed at the front end of the plastic base, and the second plate extends to a rear side of the plastic base.

3. The electrical connector according to claim 1, wherein the first plate of the screw hole member is substantially flush with the projection of the metal sheath.

4. The electrical connector according to claim 1, wherein the other end of the first plate of the screw hole member is integrally connected to a third plate, which is parallel to the second plate.

5. The electrical connector according to claim 2, wherein the second plate of the screw hole member is formed with a slot at an outer end thereof, one side of each of the metal sheath and the plastic base is formed with a transversal long slot through which the second plate passes, and an upper section of the connecting element is formed with an engaging plate engaging with the slot of the second plate.

6. The electrical connector according to claim 5, wherein the other end of the first plate of the screw hole member is integrally connected to a third plate parallel to the second plate, the third plate is formed with a slot at an outer end thereof, the one side of each of the plastic base and the metal sheath is formed with another transversal long slot through which the third plate passes, the engaging block engages with one of the lateral planes of the metal sheath, and the engaging plate of the connecting element engages with the slot of the third plate.

7. The electrical connector according to claim 2, wherein an outer end of the second plate of the screw hole member is formed with a slot, one side of each of the metal sheath and the plastic base is formed with a transversal long slot, through which the second plate passes, and a circular hole, through which the screw hole is inserted, an upper section of the connecting element is formed with an engaging plate for engaging with the slot of the second plate, and the first plate is in surface contact with one of the lateral planes of the metal sheath.

8. The electrical connector according to claim 7, wherein the other end of the first plate of the screw hole member is integrally connected to a third plate parallel to the second plate, an outer end of the third plate of the screw hole member is formed with a slot, the one side of each of the metal sheath and the plastic base is formed with another transversal long slot, through which the third plate passes, and the engaging plate of the connecting element engages with the slot of the third plate.

9. The electrical connector according to claim 4, wherein each of the second and third plates of the screw hole member has an engaging block projecting out of a surface thereof, and has an engaging edge projecting out of the surface at an outer end thereof, the one side of the plastic base is formed with a transversal slot, and a rear side of the plastic base is formed with an opening, the engaging edges of the second and third plates of the screw hole member may engage with the transversal slot laterally, the engaging edge of the second plate is exposed from the opening, one side of the metal sheath is formed with an opening, through which the first plate of the screw hole member is inserted, the engaging block of the second and third plates engages with one of the lateral planes of the metal sheath, an upper section of the connecting element has an engaging plate engaging with the rear side of the plastic base, a top end of the engaging plate has a tab extending into the opening and connected to the engaging edge of the second plate.

10. The electrical connector according to claim 2, wherein the screw hole member and the connecting element are integrally connected together.

11. The electrical connector according to claim 10, wherein the connecting element is connected to the second plate of the screw hole member, the second plate has an engaging block projecting out of the surface, and an outer end formed with a laterally projecting engaging edge, each of planes on the one side of the plastic base and one side of the metal sheath is formed with an opening, through which the first plate of the screw hole member passes, a rear end of the opening of the plastic base is formed with a transversal slot, the screw hole member passes through the openings of the plastic base and the metal sheath from the rear side of the plastic base, the engaging block of the second plate engages with one of the lateral planes of the metal sheath, and the engaging edge engages with the transversal slot of the plastic base.

12. The electrical connector according to claim 11, wherein the other end of the first plate of the screw hole member is integrally connected to a third plate parallel to the second plate, the third plate has an engaging block projecting out of a surface thereof, and an outer end formed with a laterally projecting engaging edge, a rear end of the opening of the plastic base is formed with another transversal slot, the screw hole member passes through the openings of the plastic base and the metal sheath from the rear side of the plastic base, the engaging block of the second and third plates engages with one of the lateral planes of the metal sheath, and the engaging edge engages with two transversal slots of the plastic base.

13. The electrical connector according to claim 10, wherein the connecting element is connected to the second plate of the screw hole member, the second plate has an engaging block projecting out of a surface thereof, a plane on one side of the metal sheath is formed with an opening, through which the first plate of the screw hole member passes, a rear side on the one side of the plastic base is formed with a longitudinal slot, an upper section of the connecting element has an engaging plate engaging with the longitudinal slot of the plastic base from top to bottom, the screw hole member passes through the opening of the metal sheath, and the engaging block engages with a plane on the one side of the metal sheath to position the metal sheath at a front end of the plastic base.

14. The electrical connector according to claim 2, wherein the screw hole member is integrally connected to a plane on one side of the metal sheath, an outer end of the second plate of the screw hole member is formed with a slot, the one side of the plastic base is formed with a transversal long slot, through which the second plate passes, and a circular hole, through which the screw hole is inserted, an upper section of the connecting element has an engaging plate engaging with the slot of the second plate, and the first plate is in surface contact with one side of the front end of the plastic base.

15. The electrical connector according to claim 14, wherein the other end of the first plate of the screw hole member is integrally connected to a third plate parallel to the second plate, an outer end of the third plate of the screw hole member is formed with a slot, the one side of the plastic base is formed with another transversal long slot, through which the third plate passes, and the engaging plate of the connecting element engages with the slot of the third plate.

16. The electrical connector according to claim 1, wherein the first plate of the screw hole member is flush with a plane of the metal sheath.

17. The electrical connector according to claim 1, wherein the surface of the first plate is transversal, a surface of the second plate is longitudinal, the metal sheath is disposed at a top end of the plastic base, the first plate is disposed at the top end of the plastic base, and the second plate extends toward a bottom end of the plastic base.

18. The electrical connector according to claim 17, wherein the other end of the first plate is integrally connected to a third plate parallel to the second plate.

19. The electrical connector according to claim 17, wherein the one side of the plastic base is formed with a longitudinal through hole, a slot is formed on one side of the longitudinal through hole, and the second plate engages with the slot.

20. The electrical connector according to claim 18, wherein the one side of the plastic base is formed with a longitudinal through hole, slots are respectively formed on two opposite sides of the longitudinal through hole, and the second and third plates respectively engage with the slots.

21. The electrical connector according to claim 18, wherein the one side of the plastic base is formed with two longitudinal long slots, one side of the metal sheath is formed with two long slots corresponding to the two longitudinal long slots, and the second and third plates respectively pass through the two long slots of the metal sheath and one of the longitudinal long slots of the plastic base.

22. The electrical connector according to claim 18, wherein the screw hole member and the connecting element are integrally connected together, the connecting element comprises two elastic engaging sheets respectively connected to bottom ends of the second and third plates.

23. The electrical connector according to claim 17, wherein the screw hole member and the connecting element are integrally connected together, and a top end of the connecting element is connected to a bottom end of the second plate.

24. The electrical connector according to claim 18, wherein bottom ends of the second and third plates are respectively formed with slots, the connecting element has an engaging plate, and the engaging plate is assembled to and engages with the slots of the bottom ends of the second and third plates.

25. The electrical connector according to claim 18, wherein each of bottom ends of the second and third plates is formed with an engagement hole, the connecting element is formed with an engaging plate, the engaging plate is formed with two hooks, and the two hooks respectively pass through the engagement holes of the second and third plates.

26. The electrical connector according to claim 2, wherein an outer end of the second plate of the screw hole member is formed with an engagement hole, one side of each of the metal sheath and the plastic base is formed with a transversal long slot, through which the second plate passes, and an upper section of the connecting element is formed with an engaging plate passing through the engagement hole of the second plate.

27. The electrical connector according to claim 26, wherein the other end of the first plate of the screw hole member is integrally connected to a third plate parallel to the second plate, an outer end of the third plate is formed with an engagement hole, one side of each of the metal sheath and the plastic base is formed with another transversal long slot, through which the third plate passes, and the engaging plate of the connecting element passes through the engagement hole of the third plate.

28. The electrical connector according to claim 26, wherein the screw hole member is a plate-like material, which is bent into a circle to form a hollow cylinder.
